(19) United States
(12) Patent Application Publication
(10) Pub. No.: US 2015/0085519 A1
(43) Pub. Date: Mar. 26, 2015

(54) OPTICAL GRADE LIGHT PIPE

(71) Applicant: Ford Global Technologies, LLC, Dearborn, MI (US)

(72) Inventors: Ali Ammar, Dearborn, MI (US); Cornel Lewis Gardner, Romulus, MI (US); Khaled Omar, Dearborn, MI (US); Ben Sohizad, Novi, MI (US); Stuart C. Salter, White Lake, MI (US); Scott H. Dunham, Redford, MI (US)

(73) Assignee: Ford Global Technologies, LLC, Dearborn, MI (US)

(21) Appl. No.: 14/036,621

(22) Filed: Sep. 25, 2013

(51) Int. Cl. F21V 8/00

(52) U.S. Cl. CPC G02B 6/0096
USPC 362/581

(57) ABSTRACT

A light guide system includes a light pipe and a carrier member. An outwardly extending attachment flange is disposed on an outer surface of the carrier member. In assembly, the outwardly extending attachment flange is adapted to provide an attachment feature for securing the light guide system to surrounding commodities. The outwardly extending attachment flange is disposed along a length of the carrier member to ensure uniform access to the outwardly extending attachment flange and uniform securement of the light guide system to a material substrate.

### FIELD OF THE INVENTION

The present invention generally relates to a light guide system, and more specifically, to a light guide system, wherein a light pipe and a surrounding carrier substrate are formed with an elongate attachment feature extending outwardly from the carrier and used to secure the light guide system to various materials.

### BACKGROUND OF THE INVENTION

Current light guide systems require a lens, which is usually in the form of a light guide, a light panel or a light pipe, and a carrier member which is coupled to the lens and includes one or more attachment features that allow a user to fasten the light guide system to surrounding commodities. Currently, the attachment features are generally spaced along a length of the carrier member and allow for a light guide system to be coupled to various materials and surfaces at select locations. This form of securement may be suitable for applications where the light guide system is essentially concealed and primarily used as an ambient lighting feature. However, in situations where considerable lengths of light pipe are used and conspicuously placed, it is important to have assured attachment features disposed along the entire length of the light guide system to provide for uniform attachment to surrounding commodities that is free from droops or sags and is fixed in place in a controlled manner. Thus, a method of forming a light guide system is desired, wherein the carrier component includes an integrally formed attachment feature that extends substantially along the length of the carrier member.

### SUMMARY OF THE INVENTION

One aspect of the present invention includes, a light guide system comprising an optical light pipe and a carrier member. The light pipe includes a generally elongate body portion and the carrier is coupled to the light pipe along a length of the body portion of the light pipe. An attachment flange extends outwardly from the carrier member along a length of the carrier member and is adapted to secure the light guide system to a material substrate.

Another aspect of the present invention includes, a light guide system comprising an optical light pipe and a carrier member. The light pipe includes a generally elongate body portion having an outer surface. The carrier member is disposed around the outer surface of the light pipe and to define a casing around the light pipe. The carrier member also extends along the entirety of a length of the light pipe. An attachment flange extends outwardly from an outer surface of the carrier member along a length of the carrier member and is adapted to secure the light guide system to a material substrate.

Yet another aspect of the present invention includes, a light guide system comprising an optical light pipe and a carrier member. The light pipe includes a generally elongate body portion having an outer surface. The carrier member includes both inner and outer surfaces and is disposed around the outer surface of the light pipe to form a casing around the light pipe. An attachment flange extends outwardly from the outer surface of the carrier member and includes a pierceable membrane adapted to secure the light guide system to a material substrate.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is an fragmentary perspective view of a light guide system according to one embodiment;

FIG. 2 is a crossectional view of the light guide system of FIG. 1 taken at line II;

FIG. 3 is crossectional view of the light guide system as coupled to a material substrate;

FIG. 4 is a fragmentary perspective view of a vehicle seat having a light guide system secured thereto; and

FIG. 5 is a top perspective view of a vehicle floor mat having a light guide system secured thereto.

### DETAILED DESCRIPTION OF THE PREFERRED EMBODIMENTS

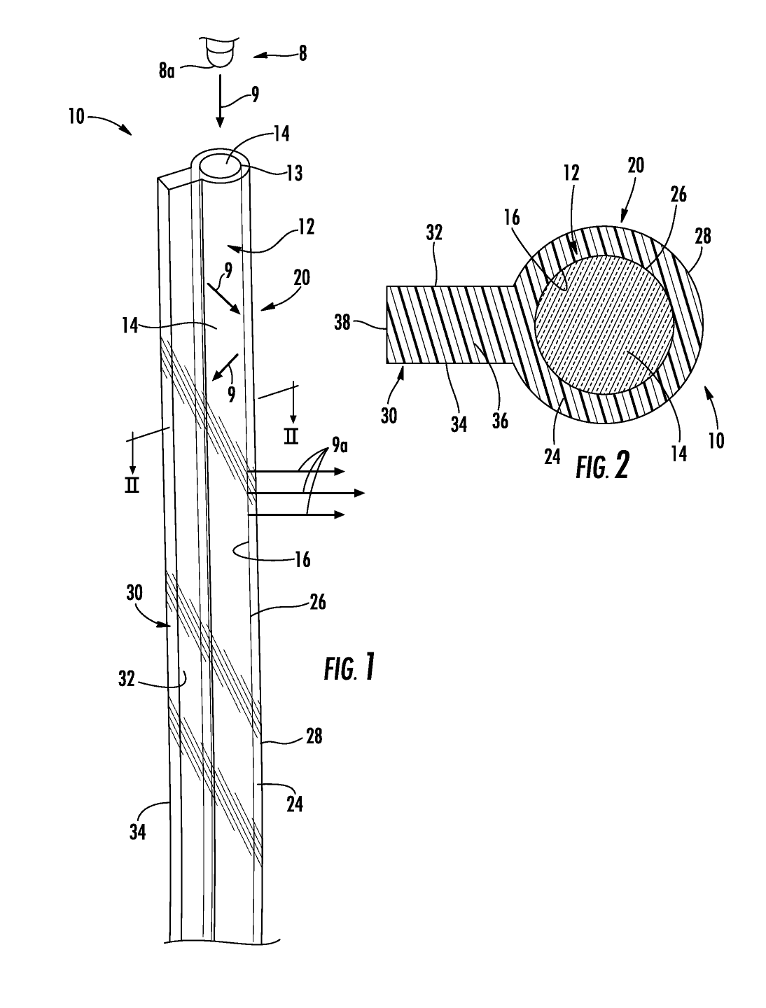

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIG. 1, the reference numeral 10 generally designates a light guide system according to one embodiment of the present invention. As shown in FIG. 1, the light guide system includes an optical grade light pipe 12 which is a substantially translucent pipe suitable for transmitting light as emitted from a light source 8, as further described below. The light pipe 12 includes an elongate body portion 14 having an outer surface 16. The light pipe 12 is generally formed from a material R1 which may be a rigid material that is comprised of a curable substrate such as a polymerizable compound, a mold in clear (MIC) material or mixtures thereof. Acrylates are also commonly used for forming rigid light pipes, as well as poly (methyl methacrylate) (PMMA) which is a known substitute for glass. A polycarbonate material may also be used in an injection molding process to form a rigid light pipe 12. Further, the light pipe 12 may be a flexible light pipe, wherein a suitable flexible material, also indicated as R1, is used to create the light pipe 12. Such flexible materials include urethanes, silicone, thermoplastic polyurethane (TPU) or other like optical grade flexible materials. Whether the light pipe 12 is a flexible light pipe or a rigid light pipe, the light pipe 12, when formed, is substantially optically transparent and capable of transmitting visible light. In this way, the light pipe 12 is a lens for the light guide system 10. The light pipe 12 may be referred to as a light guide, a light plate, a light bar or any other light carrying substrate made from a transparent or substantially translucent plastic that is adapted to reflect and propagate light along a length thereof For purposes of this disclosure, the light pipe 12 and the material R1 used to form the light pipe 12 will be described herein as a flexible optical grade light pipe.

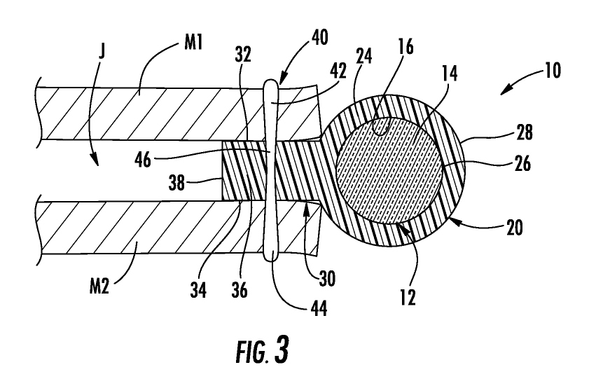

A carrier member 20 is shown in FIG. 1 as defining a molded casing 24 around the outer surface 16 of the light pipe 12 for supporting the clear lens light pipe 12 as shown in FIG. 2. The carrier member 20 is generally comprised of a material R2 which is typically a polycarbonate material that may also be a blend of a polycarbonate material and an acrylonitrile butadiene styrene (ABS) plastic. The carrier member 20 of the present invention is generally an optically transmissive member having an inner surface 26 and an outer surface 28 disposed about the casing portion 24. As shown in FIG. 1, the light guide system 10 includes an optically transparent light pipe 12 that is adapted to receive light at an input end 13 from a light source 8. The light source 8 may include a plurality of light emitting diodes (LEDs) 8a positioned such that light 9 emitted from the LEDs 8a enters the input end 13 of the light pipe 12. The light pipe 12 is designed to provide internal reflection of the light 9 entering the light pipe 12, such that the light 9 is reflected along an outer surface 16 of the light pipe 12 as the light 9 travels along the length of the light pipe 12 with minimal light loss. In order to minimize the amount of light lost within the light pipe 12, the light pipe 12 has an index of refraction that is higher than the index of refraction of the carrier member 20. The index of refraction describes how light propagates through a particular medium. Thus, in the light guide system 10 of the present invention, light 9 emitting from the light source 8 is reflected within a body portion 14 of the light pipe 12 with nearly total or complete internal reflection within the body portion 14 of the light pipe 12 with little light absorption. Thus, the light 9 entering light pipe 12 is internally reflected and then selectively emitted through the outer surface 28 of the carrier member 20 as indicated by arrows 9a. The light 9a exiting the outer surface 28 of the carrier member 20 is contemplated to have been reflected multiple times within the body portion 14 of the light pipe 12. The outer surface 16 of the light pipe 12 can be etched or otherwise textured to increase the effective surface area, thereby causing more light 9a to exit through the outer surface 28 of the carrier member 20 at select etched regions. Further, the texturing of the outer surface 16 of the light pipe 12 and the outer surface 28 of the carrier member 20 can be designed to evenly diffuse the light 9a as it exits the light pipe 12, thereby minimizing variations in the brightness of the light 9a emitting from the outer surface 28 of the carrier member 20.

Known methods of providing a light pipe and a carrier member involves the bonding of a preformed light pipe to a preformed carrier member by adhesion, such as by using a double-sided tape, or by mechanical connections such as brackets that are formed into the carrier substrate. The present invention seeks to avoid these connector mechanisms by providing an integrally formed the light pipe 12 and the carrier member 20 in a single process to form a unitary light guide system 10. By co-molding or extruding the light pipe 12 and the carrier member 20 of the light guide system 10, gaps that are typically formed in the prior art connection methods are greatly reduced or altogether eliminated. This provides a thinner or lower overall profile for the light guide system 10 of the present invention which can be a critical feature for a light guide system as used in applications having limited free space in an area where ambient lighting is desired. Further, the minimized gaps between the light pipe 12 and the carrier member 20 of the present invention reduces light leakage between the two substrates in use.

As further shown in FIG. 1, the carrier member 20 includes an outwardly extending attachment flange 30 which generally extends from the outer surface 28 of the carrier member 20. The attachment flange 30 includes first and second surfaces 32, 34 having a body portion 36 disposed therebetween. In the embodiment shown in FIG. 1 and FIG. 2, the attachment flange 30 further includes a terminal end 38. As best shown in FIG. 1, the outwardly extending attachment flange 30 is disposed on the carrier member 20 along an entirety of a length of the carrier member 20, such that the attachment flange 30 is an elongate attachment flange extending along an entirety of a length of the light guide system 10. In this way, the outwardly extending attachment flange 30 is adapted to be used to secure the light guide system 10 to a variety of material substrates as further described below. With the attachment flange 30 extending along the entire length of the light guide system 10, the light guide system 10 of the present invention provides assured access to an attachment location at all points along the light guide system 10. Thus, the outwardly extending attachment flange 30 can be used as an attachment location for an infinite number of securement points disposed along the body 36 of the attachment flange 30. In this way, the light guide system 10 of the present invention differs from the prior art where attachment features of the prior art are generally spaced apart along a length of a light guide system such that corresponding attachment features must be disposed on a surrounding commodity to which a light guide system of the prior art is to be secured. The present invention eliminates the need to configure a light guide system with attachment features adapted to match the attachment locations of a surrounding commodity. The uniform connection that is achieved with the outwardly extending engagement flange provides for a uniform appearance of the light guide system 10 as secured to a surrounding commodity. Specifically, the light guide system 10 can be evenly secured to a surrounding commodity, such that the light guide system 10, and more particularly a flexible light guide system 10, will not droop or sag between attachment locations as found in prior art applications.

The attachment flange 30 can be co-molded with the carrier member 20, or the attachment flange 30 could be an extruded part which is molded onto the carrier member 20 separately. It is contemplated that both the attachment flange 30 and the carrier member 20 can be flexible polymeric parts, such as the overall light guide system 10 is flexible so as to be suitable for following the contours of a feature disposed within a vehicle interior to which the light guide system 10 is attached.

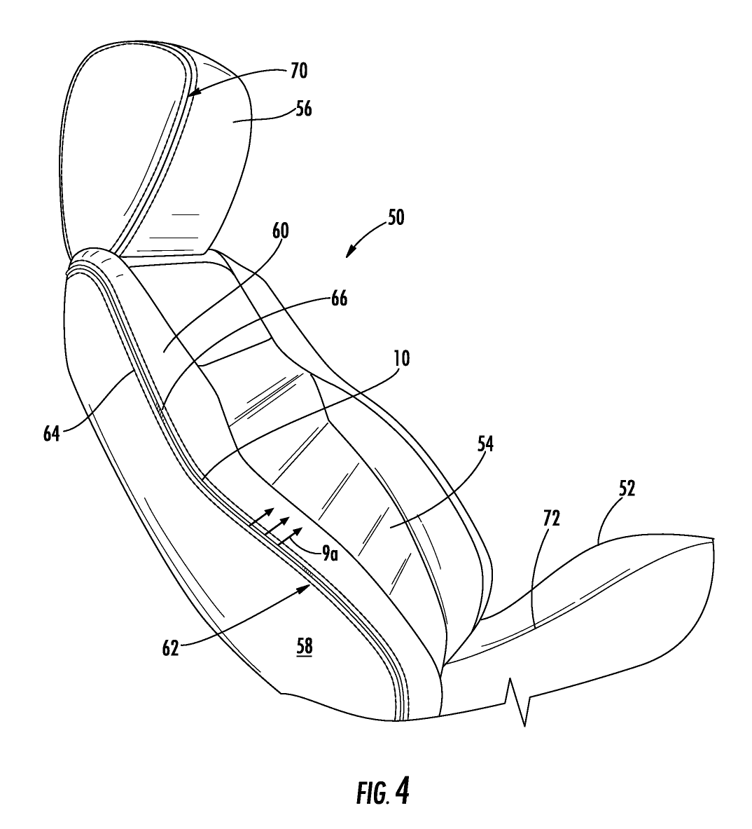

Referring now to FIG. 3, the light guide system 10 is shown having the outwardly extending attachment flange 30 disposed between first and second material substrates M1, M2. As noted above, the attachment flange 30 includes first and second surfaces 32, 34 which are disposed adjacent to material substrates M1, M2. As further shown in FIG. 3, the body portion 36 of attachment flange 30 is essentially sandwiched between the first and second material substrates M1, M2, such that a coupling mechanism 40 couples the material substrates M1, M2 to the attachment flange 30. The coupling mechanism 40 includes first and second ends 42, 44 disposed on opposite sides of a body portion 46. In the embodiment shown in FIG. 3, the first end 42 is coupled to material substrate M1, while second end 44 is coupled to material substrate M2. The body portion 46 is shown disposed through the attachment flange 30 of the light guide system 10. In this way, the light guide system 10 is coupled to material substrates M1, M2 at a junction J disposed there between. The coupling mechanism 40 may be selected from any number of coupling mechanisms known in the art, such as a threaded stitch, a staple, a wire, and may also include other coupling forms, such as adhesives and the like.

Thus, attachment flange 30 is a pierceable attachment flange when used with mechanical fasteners, such as a staple or a stitch, such that the attachment flange 30 is adapted to retain its structural rigidity when used in conjunction with coupling mechanism 40. As noted above, the attachment flange 30 may be comprised of a polymeric material which is suitable for piercing and coupling to a material substrate.

In this way, the attachment flange 30 is both pierceable and flexible, such that the attachment flange 30 can be used with a flexible light guide system 10 to follow the contours of a vehicle feature, for example vehicle seat or a floor mat as further described below.

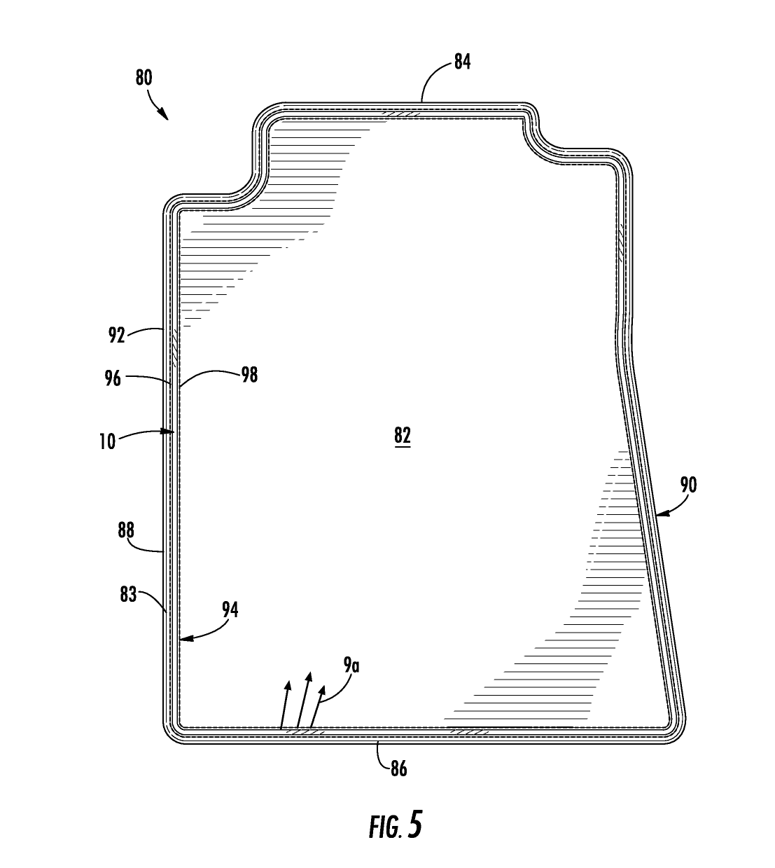

Referring now to FIG. 4, a vehicle seat 50 is shown having a seat portion 52, a backrest portion 54 and a headrest portion 56. Referring specifically to the backrest portion 54, a side panel 58 is shown coupled to a front panel 60. The panels 58, 60 are coupled together via a stitching arrangement 62 which includes stitching patters 64, 66 which are disposed along exterior edges of the panels 58, 60. A light guide system of the present invention 10 is shown disposed within the stitching arrangement 62 as located between stitching patterns 64, 66. In this way, the light guide system 10 is secured to the material substrates making up panels 58, 60 in an arrangement similar to the arrangement shown in FIG. 3. Thus, the light guide system 10 is disposed at a seam or junction J of the material substrates for panels 58, 60. As disposed on the vehicle seat 50, along the stitching arrangement 62, the light guide system 10 is adapted to emit light, as indicated by arrows 9A, as received from a light source for eliminating select portions of the vehicle seat 50. While the light guide system 10 of the present invention is showed coupled to a side panel 58 and front panel 60 at a junction therebetween, it is contemplated that the light guide system 10 of the present invention could be coupled to any portion of the vehicle seat 50 using attachment flange 30 as described above. Other such locations include scene 70 disposed on headrest portion 56, or scene 72 disposed on seat portion 52. Now shown in this example as coupled to a seam location, the light guide system 10 of the present invention may be coupled anywhere to the material used to make up the vehicle seat cover of vehicle seat 50 as the attachment flange 30 of the light guide system 10 is not limited to couplings disposed along a seam.

Referring now to FIG. 5, a floor mat 80 is shown having a body portion 82 having front and rear sides 84, 86 and side portions 88, 90. Together the sides 84, 86, 88 and 90 define a perimeter 92 of the floor mat 80. With specific reference to side 88, a stitching arrangement 94 is shown having stitching patterns 96 and 98. The stitching arrangement 94 is disposed along a seam or junction between the body portion 82 of the floor mat 80 at an outer lining 83 which is disposed about the perimeter 90 of the floor mat 80. Thus, the stitching arrangement 94 couples the lining 83 to the body portion 82 using stitching patterns 96, 98. As further shown in FIG. 5, a light guide system 10 is coupled to the floor mat 80 at the stitching arrangement 94 by stitching patterns 96, 98. In this way, the light guide system 10 is disposed along the perimeter 90 of the floor mat 80 in what is contemplated to be a similar arrangement as shown with respect to FIG. 3. Being disposed on the upper surface of a body portion 82 of the floor mat 80, the light guide system 10 is adapted to emit light, as indicated by arrows 9A, from the floor mat into a vehicle interior. It is contemplated that the floor mat 80 may include a power outlet, or other like receptacle, disposed on the underside of the body portion 82 for powering the light guide system 10.

While the light guide system 10 of the present invention has been shown as coupled to a vehicle system 50 and a floor mat 80 in FIGS. 4 and 5, it is contemplated that the light guide system 10 can also be coupled to any feature disposed within a vehicle interior where ambient light is desired.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A light guide system, comprising:
a light pipe having a body portion;
a carrier member coupled to the light pipe along a length of the body portion; and
an attachment flange extending outwardly from the carrier member along a length of the carrier member, wherein the attachment flange is adapted to secure the light guide system to a material substrate.

2. The light guide system of claim 1, wherein the light pipe is translucent.

3. The light guide system of claim 2, wherein the carrier member defines a molded casing about the light pipe.

4. The light guide system of claim 3, wherein the light pipe is adapted to propagate light as received from a light source along a length of the body portion.

5. The light guide system of claim 4, wherein the carrier member is adapted to emit light from the light pipe to provide an ambient lighting feature.

6. The light guide system of claim 5, wherein the carrier member, the light pipe and the attachment flange are flexible.

7. The light guide system of claim 6, wherein the attachment flange is pierceable and adapted to receive a coupling mechanism for coupling the light guide system to the material substrate.

8. A light guide system, comprising:
a light pipe having an outer surface;
a carrier member disposed around the outer surface of the light pipe defining a casing around the light pipe; and
an attachment flange extending outwardly from an outer surface of the carrier member along an entirety of a length of the carrier member, wherein the attachment flange is adapted to secure the light guide system to a first material substrate.

9. The light guide system of claim 8, wherein the light pipe is adapted to propagate light as received from a light source along a length of a body portion.

10. The light guide system of claim 9, wherein the carrier member is adapted to emit light from the light pipe to provide an ambient lighting feature.

11. The light guide system of claim 10, wherein the carrier member, the light pipe and the attachment flange are flexible.

12. The light guide system of claim 11, wherein the attachment flange is pierceable and adapted to receive a coupling mechanism for coupling the light guide system to the material substrate.

13. The light guide system of claim 12, wherein the attachment flange is adapted to be received between the first material substrate and a second material substrate, such that the light guide system is disposed along a seam between the first and second material substrates.

14. The light guide system of claim 13, including:
a coupling mechanism adapted to engage the attachment flange and the first and second material substrates, to secure the light guide system thereto.

15. The light guide system of claim 14, wherein the coupling mechanism comprises a stitching arrangement.

16. A light guide system, comprising:
a light pipe having an outer surface;
a carrier member having inner and outer surfaces, the inner surface disposed around the outer surface of the light pipe to form a casing around the light pipe; and
an attachment flange extending outwardly from the outer surface of the carrier member, wherein the attachment flange includes a pierceable membrane adapted to secure the light guide system to a material substrate.

17. The light guide system of claim 16, including:
a coupling mechanism adapted to engage the attachment flange and the material substrate, to secure the light guide system thereto.

18. The light guide system of claim 14, wherein the coupling mechanism comprises a stitching arrangement.

19. The light guide system of claim 16, wherein the attachment flange is an elongate attachment flange disposed substantially along a length of the carrier member.

20. The light guide system of claim 19, wherein the light pipe defines a transparent lens capable of reflecting and propagating light along a length thereof.
